(19) United States
(12) Patent Application Publication
(10) Pub. No.: US 2024/0375808 A1
(43) Pub. Date: Nov. 14, 2024

(54) HOLDING DEVICE FOR A CONTAINER, AND APPARATUS FOR THE PROCESSING OF CONTAINERS

(71) Applicant: Bausch + Stroebel SE & Co. KG, Ilshofen (DE)

(72) Inventors: Andreas Boehmike, Ilshofen (DE); Steffen Heier, Ilshofen (DE); Klaus Kaiser, Ilshofen (DE); Daniel Spieler, Ilshofen (DE); Sebastian Faerber, Ilshofen (DE); Manuel Wallisch, Ilshofen (DE)

(21) Appl. No.: 18/781,306

(22) Filed: Jul. 23, 2024

Related U.S. Application Data
(63) Continuation of application No. PCT/EP2023/051822, filed on Jan. 25, 2023.

(30) Foreign Application Priority Data
Jan. 28, 2022 (DE) 10 2022 101 994.2

(51) Int. Cl. B65B 43/46; B65B 3/00; B65G 47/90

(52) U.S. Cl. CPC B65B 43/46; B65B 3/006; B65G 47/90; B65G 2201/0235

(57) ABSTRACT

Containers, such as pharmaceutical containers, are held in an apparatus for processing containers by a holding device. The holding device has a main body and a container receptacle with at least one abutment element for the container. The containers have a direction of extent extending in a receptacle direction of the container receptacle. The container is positionable against the abutment element to assume a defined position. A holding element can hold the container in the container receptacle. The holding element is movably mounted on the main body between a release position, in which the container is insertable into the container receptacle in an insertion direction oriented transversely to the receptacle direction, to a holding position, in which the holding element engages behind the container and acts upon the container with a holding force oriented in the direction of the container receptacle to hold the container with clamping action.

### CROSS-REFERENCE TO RELATED APPLICATIONS

This application is a continuation of International Application No. PCT/EP2023/051822, filed on Jan. 25, 2023, and claims priority to German Application No. 10 2022 101 994.2, filed on Jan. 28, 2022. The contents of International Application No. PCT/EP2023/051822 and German Application No. 10 2022 101 994.2 are incorporated by reference herein in their entireties.

### FIELD

The present disclosure relates to a holding device for holding an, in particular, pharmaceutical container in an apparatus for the processing of containers, in particular pharmaceutical containers.

Moreover, the present disclosure relates to an apparatus for the processing of pharmaceutical containers.

### BACKGROUND

In such an apparatus, the containers typically run through different types of processing stations from an inlet to an outlet (which can also be referred to as processing devices). For example, the containers supplied via the inlet are first weighed, subsequently filled, weighed again, closed, and decoupled via the outlet. It is conceivable here that processing stations be combined spatially and functionally. For example, only one weighing station is used at which the containers are initially weighed empty (tare weighing), filled and subsequently weighed in the filled state (gross weighing).

The containers may, in particular, be pharmaceutical containers, such as syringes, carpules, ampoules and/or vials. In the present case, “containers” may also comprise other types of packaging means-for example, cosmetic containers.

A transport device is typically used for transporting the containers in the apparatus. In a clocked transport device, the containers are processed, for example, in a plurality of groups or individually. For this purpose, the containers are temporarily set down or kept at a processing station, preferably in a defined position. The same applies if the containers have to be “temporarily parked,” for example before processing in a processing station or between successive processing stations.

For this purpose, stable containers, for example vials, can be set down on a set-down element, for example. The situation is different with so-called non-stable containers which, due to their geometry, do not stand on their own and therefore have to be fixed in some other way. Non-stable containers include, for example, syringes (including possible needle protection), carpules or ampoules, wherein other types of packaging means are also conceivable.

### SUMMARY

The object of the present disclosure is to provide a holding device for a, in particular, pharmaceutical container, with which, in particular, non-stable containers can be reliably held. In addition, the object of the present disclosure is to provide an apparatus for the processing of containers with at least one such holding device.

This object is achieved by a holding device in accordance with the present disclosure for holding a longitudinally extended, in particular, pharmaceutical container having an direction of extent in an apparatus for the processing of containers, wherein the holding device comprises a main body, a container receptacle with at least one abutment element for the container, against which at least one abutment element the container is positionable in order to assume a defined position on the holding device, wherein the direction of extent extends in a receptacle direction of the container receptacle, and at least one holding element for holding the container in the container receptacle, wherein the at least one holding element is movably mounted on the main body and is transferrable from a release position, in which the container is insertable into the container receptacle in an insertion direction, which is oriented transversely and, in particular perpendicularly, in relation to the receptacle direction, into a holding position in which the holding element engages behind the container at least in portions and, in order to hold it with clamping action, acts upon said container with a holding force in the direction of the container receptacle.

The holding device in accordance with the present disclosure is provided, in particular, for holding longitudinally extended containers, for example syringes, carpules, or ampoules. When the holding device is used as intended, the container can thus be arranged in the receptacle against the at least one abutment element such that the direction of extent of the container and the receptacle direction coincide. References to the receptacle direction can accordingly also be references to the direction of extent of the container if the holding device is used in accordance with the specification.

In accordance with the present disclosure, it is provided that at least one holding element is movably mounted on the main body. Due to the movable mounting, a reliable function of the holding device is ensured even in the case of frequent and repeated use, and preferably high process reliability is ensured. In the release position of the at least one holding element, the container is insertable into the container receptacle transversely and, in particular perpendicularly, to the container direction (and thus the direction of extent). In the case of a conventional alignment of the container in a height direction, this creates, for example, the possibility of avoiding lifting movements when the container is inserted into the container receptacle and when it is removed from the container receptacle. Lifting movements are undesirable, for example, in apparatuses for processing, in particular, pharmaceutical containers to prevent abrasion, especially in highly sensitive isolation areas. It may be provided, for example, that the container direction is oriented along the direction of gravity and the direction of extent in a vertical plane.

In the holding position, the at least one holding element at least partially engages behind the container. The holding element is positionable against the outside, for example, on a lateral surface of the container, and act upon it with a holding force in the direction of the container receptacle. In this way, the container is reliably held in the container receptacle and thereby assumes a defined position as a result of the at least one abutment element. This facilitates, for example, the use of the holding device at a weighing station and/or at a filling station. The movable mounting of the at least one holding element preferably further makes it possible to prevent a clamped retention of the container by crumpling the holding element and the undesired abrasion of the holding element associated therewith.

The holding device is preferably configured to hold containers of different sizes, for example, for holding syringes of different diameters. Accordingly, it may preferably be provided that the holding element can assume a plurality of release positions and/or a plurality of holding positions, depending on the corresponding container.

In particular, the holding device can in this way cover a so-called “format range” of pharmaceutical containers which includes all or at least most of the container types and/or container sizes that are processed with the apparatus for the processing of the containers.

It may be provided that the container receptacle and/or the at least one holding element are format parts which can be exchanged depending on the containers to be processed.

The insertion direction preferably extends in a plane perpendicular to which the receptacle direction is oriented.

It is advantageous if the holding device comprises at least one biasing element for applying a biasing force acting to the at least one holding element in the direction of the holding position. In this way, a reliable function of the holding device can be ensured. The holding force can be exerted on the container via the biasing force, which holding force holds it in the container receptacle.

The at least one biasing element may be operatively connected directly or indirectly to the at least one holding element.

The at least one biasing element is configured, for example, as a mechanical spring which is in operative connection with the at least one holding element. The spring is, for example, a compression spring or a tension spring.

It may be provided that the at least one biasing element is or forms a magnetic element. For example, the magnetic element is in operative connection with the holding element. An attraction or repulsion of the magnetic element leads, for example, to the biasing force.

It may, in particular, be provided that, starting from a base position which the at least one holding element assumes in the absence of a container in the container receptacle, the at least one holding element is transferrable into the release position against the action of at least one return element and from the release position to the base position under the action of the at least one return element. For example, the at least one holding element assumes the base position before the container is inserted into the container receptacle or after the container has been removed from the container receptacle.

The at least one holding element is transferred from the base position into the release position, for example, with the widening of an insertion opening of the container receptacle. By reducing the insertion opening, the at least one holding element is transferrable from the release position into the holding position, for example. The reverse applies when the container is removed from the container receptacle.

Accordingly, an expandable insertion opening of the container receptacle may be provided.

It is advantageous if the at least one biasing element comprises or forms the at least one return element. This enables a structurally simple configuration and a compact design of the holding device. Separate components for the biasing element and the return element can be dispensed with.

It is particularly advantageous if the holding device is configured to be passive. For example, the holding device is free of a drive for the at least one holding element.

The at least one holding element can preferably be transferred from the holding position into the release position and/or from the base position into the release position by means of the container. This makes it possible to provide the holding device with a structurally simple configuration, which is advantageously free of a drive.

It is advantageous if the holding device comprises or forms two holding elements which are movably mounted on the main body and which receive the container between them at least in the holding position. By means of the two holding elements, the container can be held even more reliably in the container receptacle. For example, the holding elements have a preferably variable distance from one another in a plane transverse and, in particular, perpendicular to the receptacle direction and to the insertion direction.

For example, it may be provided that the holding elements, starting from the corresponding release position, approach one another during the transfer into the corresponding holding position and are conversely moved away from one another. In a corresponding manner, it may be provided that the holding elements are moved away from one another starting from an optional corresponding base position during the transfer into the corresponding release position, and vice versa.

For transferring from the corresponding holding position into the corresponding release position, the holding elements can, in particular, be spread relative to one another. The same applies to the transfer from the corresponding optional base position to the corresponding release position.

The holding elements are preferably arranged and/or configured symmetrically or substantially symmetrically relative to one another in relation to a plane of symmetry through the container receptacle. Due to the symmetrical configuration and/or arrangement, the container can be held in the container receptacle in a reliable position. This enables high process reliability when the holding device is used.

It can be particularly advantageous if the holding elements are directly or indirectly coupled to one another. In this case, a biasing element and/or a return element of the holding device can preferably engage directly or indirectly on the holding elements and preload them relative to one another in relation to the holding position and/or the base position. This makes it possible, for example, to provide only one biasing element which preloads the holding elements together from the corresponding release position into the corresponding holding position. In a corresponding manner, only one return element may be provided which transfers the corresponding holding elements from the release position into the corresponding base position. It proves to be particularly advantageous here if the biasing element comprises or forms the return element.

The biasing element and/or the return element are in operative connection with coupling elements, for example, which in turn may be connected to the holding elements.

The coupling of the holding elements preferably allows self-centering of the holding elements when inserting or removing the container.

Preferably, the two holding elements are configured to be functionally identical.

The at least one holding element is preferably pivotable on the main body about a pivot axis. The pivot axis preferably extends parallel to the receptacle direction.

A reliable function of the holding device can be ensured via the pivotable mounting of the at least one holding element. Alternatively or additionally, a displaceable mounting of the at least one holding element on the main body may be provided.

The pivot axis is preferably arranged behind the at least one abutment element relative to the insertion direction. In the present case, this can be understood, in particular, that the pivot axis is arranged on the side of the abutment element facing away from the container.

The pivot axis extends, for example, transversely and, in particular, perpendicularly to a plane of the main body.

The at least one holding element comprises, for example, a mounting portion for movable mounting on the main body, a holding portion for positioning against the container in the holding position, and a connecting portion connecting the mounting portion to the holding portion. The mounting portion and the holding portion may, for example, be aligned parallel to one another. The mounting portion interacts, for example, with a corresponding bearing element on the main body.

The connecting portion, for example, extends starting from the main body counter to the insertion direction and/or is arranged laterally next to the container received in the container receptacle.

It may be favorable if the mounting portion engages in the main body and/or a housing of the holding device from below relative to a direction of gravity, and if the connecting portion is arranged in portions below the main body. By engaging from below, the mounting of the at least one holding element on the main body is protected. Any contamination cannot penetrate into the holding device, or only with very low probability.

A holding member for positioning against the container is preferably arranged or formed on the holding portion, in particular, for positioning in the holding position of the at least one holding element.

In relation to a plan view along the receptacle direction, the holding member preferably projects beyond a free end of the connecting portion that faces away from the main body. In this way, it can be ensured, for example, that the container is only contacted by the holding member, but not by the connecting portion. The holding member is preferably configured to be optimized with regard to non-damaging retention of the container in the container receptacle.

In relation to a plan view along the receptacle direction, the holding member is preferably configured circular.

In a preferred embodiment of the present disclosure, the holding member may, for example, be formed to be disk-shaped.

It is favorable if the holding member is configured to be rotatable. For example, the container can rotate the holding member when inserted into the container receptacle and/or when removed from the container receptacle. This preferably makes it possible to avoid abrasion of the holding member and/or of the container.

For example, the holding member is configured to be rotatable relative to a holding projection of the holding portion projecting from the connecting portion and is, in particular, rotatably mounted on the holding projection. An axis of rotation is preferably oriented in parallel with the container direction.

A bearing element is preferably provided on the holding projection via which the holding member is rotatably mounted on the holding projection. The bearing element is configured, for example, as a ball bearing.

It can prove favorable if the holding member overlaps the bearing element, whereby a sealing of the bearing element can preferably be achieved.

The holding projection is, for example, aligned parallel to the mounting portion.

The holding member is preferably made of an abrasion-resistant material. It is, for example, conceivable that it is made of a plastics material, for example PEEK (polyether ether ketone).

The holding member is preferably made of a material that is non-damaging to the container. In this way, damage to the container, for example scratches in glass containers, during contact with the holding member can be avoided.

It has already been mentioned that the holding device can preferably comprise two holding elements.

For example, it is provided that the holding device comprises two holding elements comprising a respective holding member which are positionable against the container at different positions in relation to the receptacle direction. The holding members can, for example, be spaced apart from one another longitudinally along the receptacle direction.

In the case of a pivotably mounted at least one holding element as mentioned above, the holding device may preferably comprise at least one coupling element which is in a pivotally fixed manner connected to the at least one holding element and is arranged at least in portions on side of the pivot axis opposite to this holding element. The holding device may, for example, comprise a pivot body which is formed as a two-armed lever. The at least one holding element can form the first lever arm therefrom, and the at least one coupling element can form the second lever arm. If a force acts on the at least one coupling element, this force can be transmitted to the at least one holding element.

Preferably, at least one biasing element and/or at least one return element of the holding device engages on the at least one coupling element. In this way, a biasing force and/or a return force can be transmitted to the at least one holding element.

In the case of two holding elements, it is preferably provided that the at least one biasing element and/or the at least one return element is operative between the coupling elements. For example, a compression spring or a tension spring is provided which is operative between the coupling elements. Alternatively or additionally, for example, magnetic elements can be used.

The at least one coupling element is preferably arranged above the main body and/or covered by a cover element of the holding device. In the present case, “above” is, in particular, related to a direction of gravity. “Above” can be understood as “on a side of the main body facing away from the connecting portion.”

Expediently, the holding device comprises or forms a cover element which covers the main body at least in portions and is preferably free of openings on an upper side. For example, the cover element covers a receiving space of the holding device in which the at least one coupling element and the at least one biasing element and/or return element is or are arranged.

The at least one abutment element is preferably arranged, relative to the insertion direction, on the end face of the cover element. The abutment element may, in particular, be formed integrally with the cover element, for example may, be molded onto it. Alternatively, the at least one abutment element may be formed separately from the cover element and/or from the main body.

It is, in particular, advantageous if the main body together with the cover element forms a housing of the holding device in which at least one biasing element and/or return element acting directly or indirectly on the at least one holding element is arranged. The main body forms, for example, a bottom of the housing, which the cover element covers, for example in the manner of a hood.

The housing may, for example, be configured cuboid.

The main body is, for example, configured plate-shaped.

The container receptacle preferably comprises a recess partially delimited by the at least one abutment element, into which recess the container can at least partially be inserted. The recess is, for example, concave.

The recess preferably tapers in the insertion direction. In this way, the container can preferably be guided into the correct target position in the container receptacle.

In a preferred embodiment of the present disclosure, the at least one abutment element may comprise, for example, two segments which are aligned at an angle to one another for the respective positioning against the container. For example, the segments contact a lateral surface of the container. The angle may, for example, be approximately 90° to 120°—preferably approximately 100° to 110°.

In a plan view, relative to the receptacle direction, the at least one abutment element is configured, for example, in a V-shaped or C-shaped manner.

It may prove advantageous if the container receptacle comprises two abutment elements spaced apart from one another along the receptacle direction, which are preferably configured identically. In this way, a reliable position of the container in the container receptacle can be ensured. Any component tolerances can be compensated by abutment elements spaced apart from one another.

The distance between the abutment elements is, for example, in the range of approximately 1 cm to 2 cm.

Based on the receptacle direction, a holding member of the at least one holding element may preferably be arranged between the abutment elements for positioning against the container. The container reliably contacts the abutment elements in the container receptacle. The holding member already mentioned above subjects the container to a holding force, relative to the container direction, between the abutment elements.

The container is preferably arranged in a freely suspended manner in the container receptacle. In particular, the holding device may, for example, be free of a set-down element for the container.

In an apparatus for the processing of containers, multiple containers are preferably transported in a clocked manner using a transport device. It may therefore be desirable to hold a plurality of containers with the holding device.

Accordingly, it is expedient if the holding device is configured to hold a plurality of containers and comprises a plurality of container receptacles arranged laterally next to one another. The container receptacles are preferably arranged linearly next to one another and are positioned equidistantly relative to one another. The container receptacles are preferably configured to be identical.

It is favorable if at least one holding element movably mounted on a main body for holding a corresponding container in a holding position is arranged on each container receptacle, preferably two holding elements each. At least one holding element is associated with a corresponding container receptacle, preferably two holding elements. Reference is made to the above statements regarding advantageous embodiments. The holding elements on the multiple container receptacles are preferably configured identically or functionally identically.

The holding device may, in particular, be formed strip-shaped.

It is expedient if a common main body is provided on which the holding elements are movably mounted. As a result, the holding device has a structurally simple design.

For the same reason, it is advantageous if the holding device comprises or forms a common cover element for the main body.

It may be provided that the abutment elements of the container receptacles are integrally formed with the common cover element.

A preferred embodiment of the holding device is configured to be pharmaceutical-compliant and is suitable, in particular, for use in an isolation device with which an atmosphere for decontamination purposes (for example, by means of H₂O₂) can be provided. The holding device is made, for example, of stainless steel (for example, of the type 316L (AISI/SAE) and/or of the material number 1.4404) and/or plastics, in particular POM (polyoxymethylene) or PEEK (polyether ether ketone).

As already mentioned, the present disclosure also relates to an apparatus for processing of, in particular, pharmaceutical containers.

An apparatus in accordance with the present disclosure, which achieves the object mentioned at the outset, for the processing of containers comprises at least one holding device of the type described above and at least one transport device for transferring the containers to the holding device and to transfer the containers from the holding device.

The advantages which were already mentioned in connection with the explanation of the holding device in accordance with the present disclosure can likewise be achieved with the apparatus in accordance with the present disclosure. Advantageous embodiments of the apparatus in accordance with the present disclosure result from advantageous embodiments of the holding device in accordance with the present disclosure. Reference is made to the above statements.

The holding device may, for example, be arranged at a processing station of the apparatus or may be comprised by it. Alternatively, the holding device is positioned separately from a processing station and serves, for example, to “temporarily park” the containers.

### BRIEF DESCRIPTION OF THE DRAWINGS

The following description of preferred embodiments of the present disclosure serves in conjunction with the drawing to explain the present disclosure in more detail. In the figures:

FIG. 1: shows a schematic representation of an apparatus in accordance with the present disclosure for the processing of, in particular, pharmaceutical containers in a preferred embodiment;

FIG. 2: shows a perspective representation, in particular, as a component of the apparatus from FIG. 1, a preferred embodiment of the holding device in accordance with the present disclosure and containers held thereon;

FIG. 3: shows a side view of the holding device along the arrow “3” in FIG. 2, wherein a container approaches the holding device via a transport device;

FIG. 4: shows a perspective partial representation of the holding device from FIG. 2, partially as an exploded view;

FIG. 5: shows a partial view of the holding device from FIG. 2 with a cover element being omitted and partially cut along the line 5-5 in FIG. 3, wherein holding elements of the holding device are in a base position;

FIG. 6: shows a representation corresponding to FIG. 5, wherein the holding elements are in a release position during the insertion of the container into a container receptacle;

FIG. 7: shows a partial view of the holding device from FIG. 2 in a plan view, wherein containers are inserted into the container receptacles via the transport device and the holding elements are in a release position;

FIG. 8: shows a representation corresponding to FIG. 7, wherein the containers are arranged in the receptacles and the holding elements are in a holding position;

FIG. 9: shows a perspective partial representation of a further preferred embodiment of the holding device in accordance with the present disclosure at a weighing station (partially shown), wherein a transport device is also shown;

FIG. 10: shows an enlarged representation in the region of detail A in FIG. 9;

FIG. 11: shows a front view of a holding device in accordance with the present disclosure in a partial representation, wherein the viewing direction corresponds to the arrow direction “11, 12” in the embodiment in accordance with FIG. 3; and

FIG. 12: shows a front view of a holding device in accordance with the present disclosure in a partial representation, partially cut, wherein the viewing direction corresponds to the arrow direction “11, 12” in the embodiment in accordance with FIG. 3.

### DETAILED DESCRIPTION

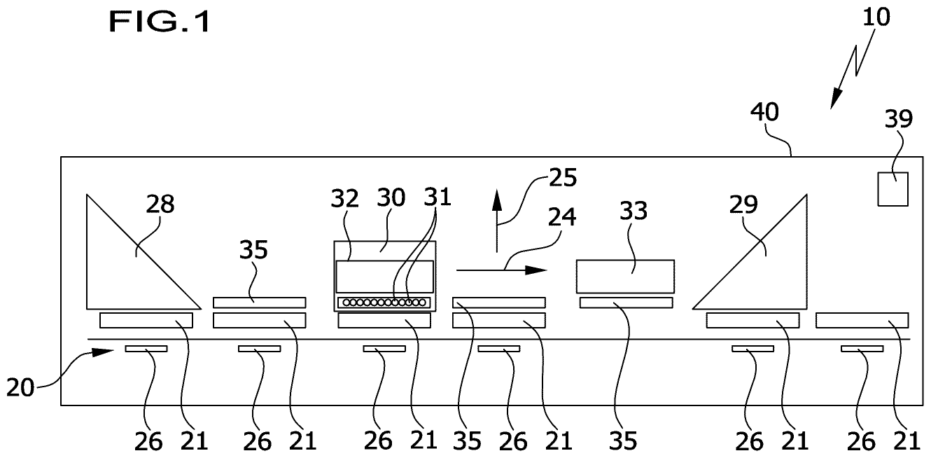

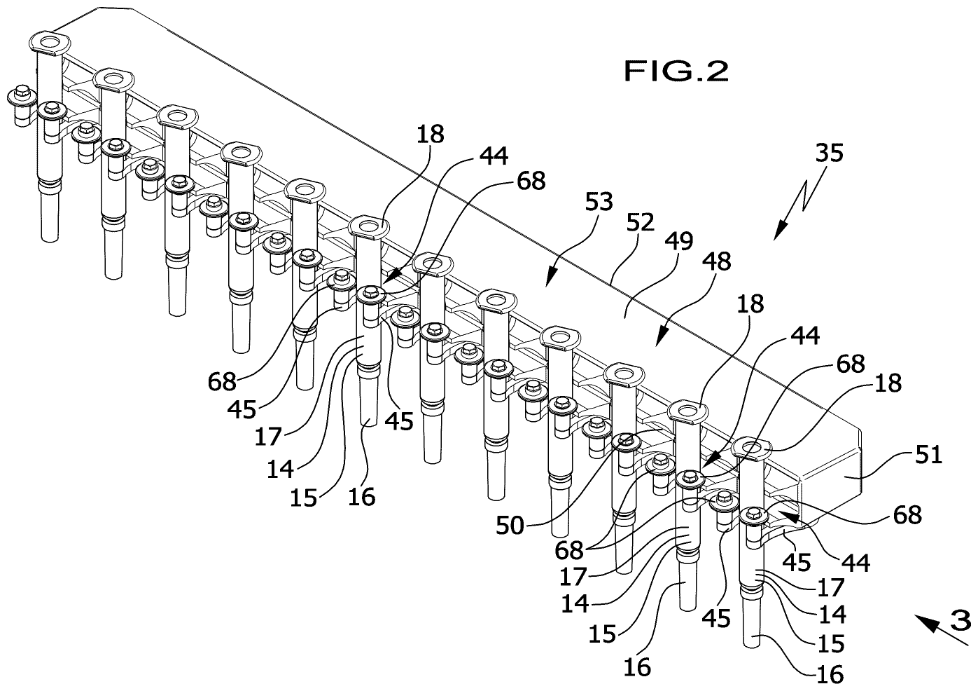

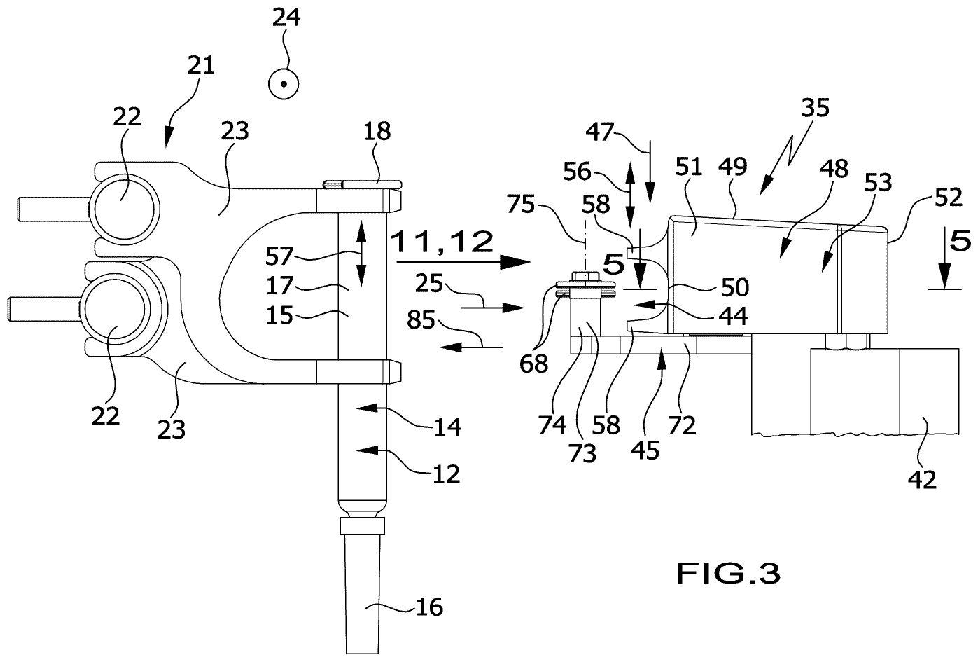

FIG. 1 shows, in a schematic representation, an advantageous embodiment of an apparatus for the processing of containers 12, which is denoted as a whole by reference numeral 10. These are pharmaceutical containers 12 in the present case. In the present example, the containers 12 are syringes 14 (for example, FIGS. 2 and 3) which have a syringe body 15 and a needle guard 16. The syringe body 15 comprises a lateral surface 17.

The syringes 14 are, in particular, non-stable containers which cannot, or only in rare cases, stand on their own on an end face formed by the needle shield 16, which end face is opposite the finger flange 18 of the syringe 14.

The apparatus 10 serves to process the containers 12 at processing stations in multiple stages. For transporting the containers 12, the apparatus 10 comprises a transport system 20 with a plurality of transport devices 21 movably arranged thereon.

The transport devices 21 are configured via so-called rakes/counter rakes. The basic principle of the transport of containers 12 with rakes/counter rakes is described using the example of Vials in DE 10 2018 213 800 A1 by the same applicant and, for this reason, is not explained further in the present case. The operating principle of the transport device 21 is neither substantial nor limiting for the present disclosure.

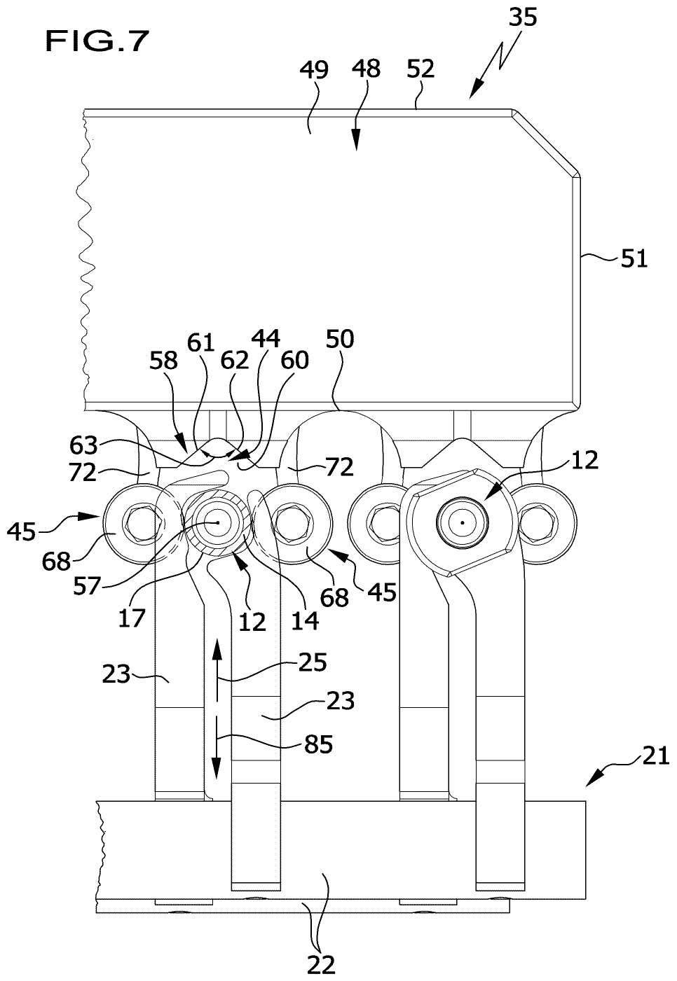

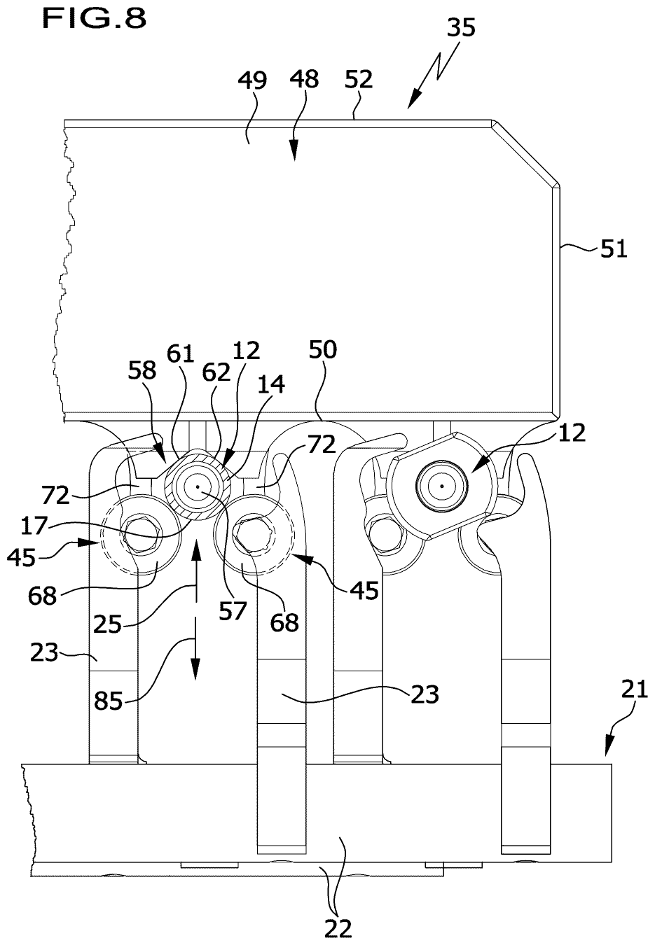

By way of explanation, with reference, in particular, to FIGS. 3, 7 and 8, it is merely stated that the rake and the counter rake each comprise a longitudinally extended holding part 22 and gripping elements 23 arranged thereon. The containers 12 can be gripped between the gripping elements 23 of both holding parts 22 (FIG. 7). If the holding parts 22 are moved in directions pointing away from one another, the containers 12 can be released (FIG. 8). By moving the holding parts 22 relative to one another in the opposite direction, the containers 12 can again be gripped with the gripping elements 23.

The transport devices 21 can be moved along a transport direction 24 of the apparatus 10 and counter thereto. In addition, the transport devices 21 can be moved transversely and, in particular, perpendicularly to the transport direction 24 in a feed direction and opposite thereto. The feed direction is referred to below as the insertion direction 25 in the drawing. The transport device 21 can be moved with or without a container 12.

The gripping and setting-down of containers 12 and the movement along the transport direction 24 and in the insertion direction 25 is described in detail in DE 10 2018 213 800 A1, to which reference is hereby made.

For moving the transport devices 21, the transport system 20 comprises drive devices 26. The transport devices 21 can be moved independently of one another.

For coupling the containers 12 at an inlet, the apparatus 10 comprises a coupling element 28. A decoupling element 29 is provided at an outlet.

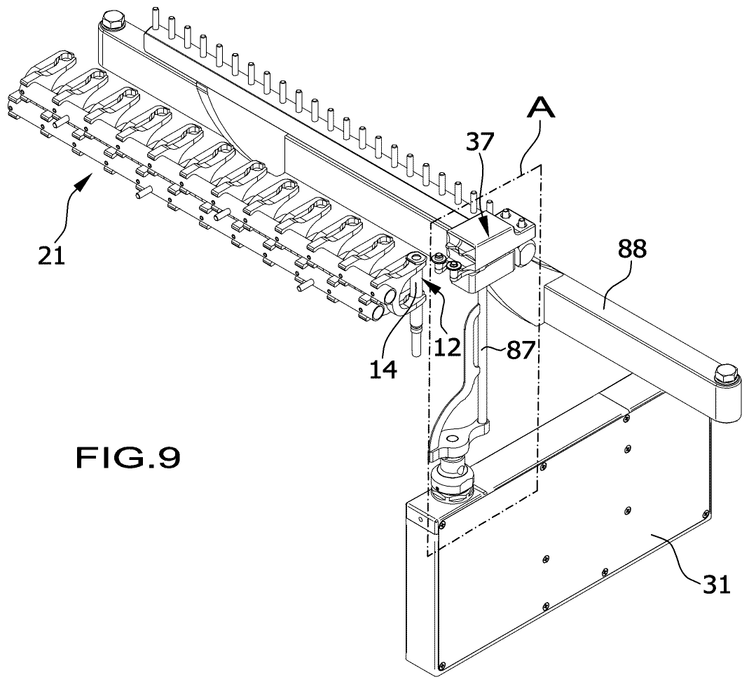

A processing station, configured as a weighing station 30 with a plurality of weighing cells 31, is provided. At the weighing station 30, the tare weight of the unfilled containers 12 and the gross weight of the filled containers 12 can be determined. FIG. 9 shows, by way of example, one of the weighing cells 31.

A further processing station is configured as a filling station 32, which is arranged at the weighing station 30 in the present example. The arrangement of the filling station 32 at the weighing station 30 results in a compact design of the apparatus 10. The gross weight can be determined during the filling process or after the filling process.

The apparatus 10 comprises a further processing station, configured as a closing station 33, downstream in the transport direction 24 of the weighing station 30 and the filling station 32. The filled containers 12 are closed at the closing station 33, for example with plugs.

The containers 12 are transported with the apparatus 10 in a clocked manner. For this purpose, it is necessary to temporarily park the containers 12 for transfer between the transport devices 21 and to hold them at the processing stations during processing.

For this purpose, the apparatus 10 comprises a holding device 35 in accordance with the present disclosure, which is explained below in a preferred embodiment, between the coupling element 28 and the weighing station 30. A further such holding device 35 is positioned downstream of the weighing station 30. A further holding device 35 is located downstream in the transport direction 24 of the closing station 33.

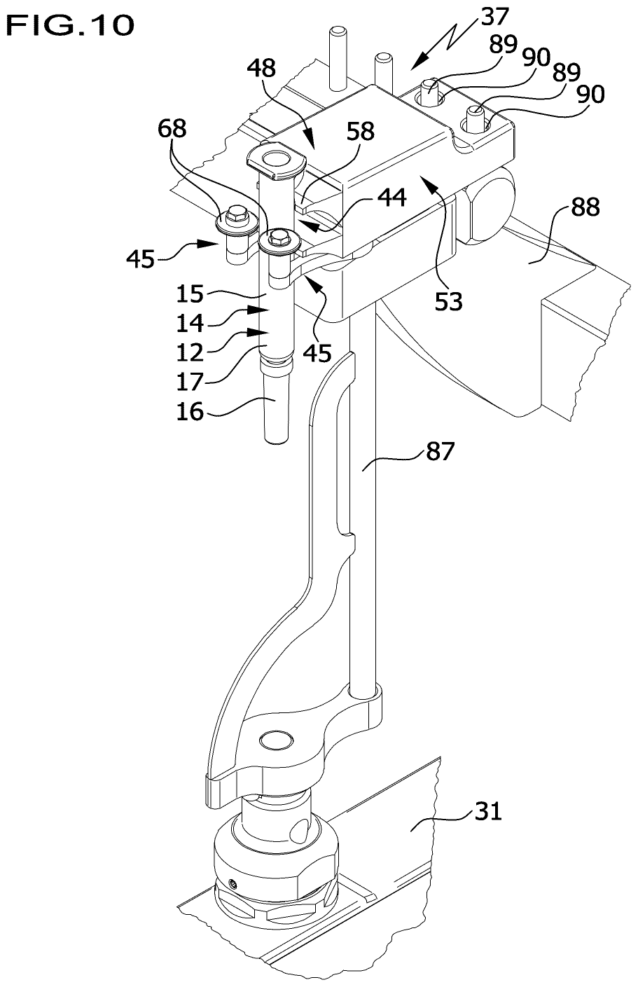

A different preferred embodiment of the holding device is associated with a respective weighing cell 31 and has the reference numeral 37. Said holding device 37 will be discussed below with reference to FIGS. 9 and 10.

The apparatus 10 comprises a control device 39 for controlling the operation. It is understood that, unless explained here, drives may be provided for movable components of the coupling element 28, the decoupling element 29 and the processing stations 30, 32, and 33.

The entirety of apparatus 10 is positioned on a frame 40 or substructure. An isolation device covering the frame 40 for providing an atmosphere for decontamination purposes may be provided, for example by means of H₂O₂.

The holding device 35 is arranged in a stationary manner on the frame 40. For this purpose, a holding part 42 partially shown in FIG. 3 may be provided, for example.

Containers 12 are transferred the holding device 35 by a transport device 21 and can be held thereon. For further processing, the containers 12 can be removed again from a transport device 21 of the holding device 35.

In the present embodiment, the holding device 35 is formed to hold multiple containers 12. In particular, it is preferably possible to hold as many containers 12 as can be transported simultaneously by means of the transport device 21. In the present example, this are 12 pieces.

As can be seen, in particular, from FIG. 2, the holding device 35 has a container receptacle 44 associated with each container 12, and arranged thereon, in each case at least one holding element 45, in particular, two holding elements 45 on each container receptacle 44. The container receptacles 44 and the holding elements 45 as well as the further components operatively connected to the holding elements 45 are configured identically in the holding device 35. For this reason, substantially only the structure and the functioning of the example of a container 12 are described below. It is understood that the relevant statements apply to each container 12 and/or the container receptacles 44 and the holding elements 45 as well as further components.

In the present case, the holding device 35 is configured strip-shaped and extends along the transport direction 24. The container receptacles 44 are arranged linearly next to one another and, in particular, are positioned equidistantly relative to one another.

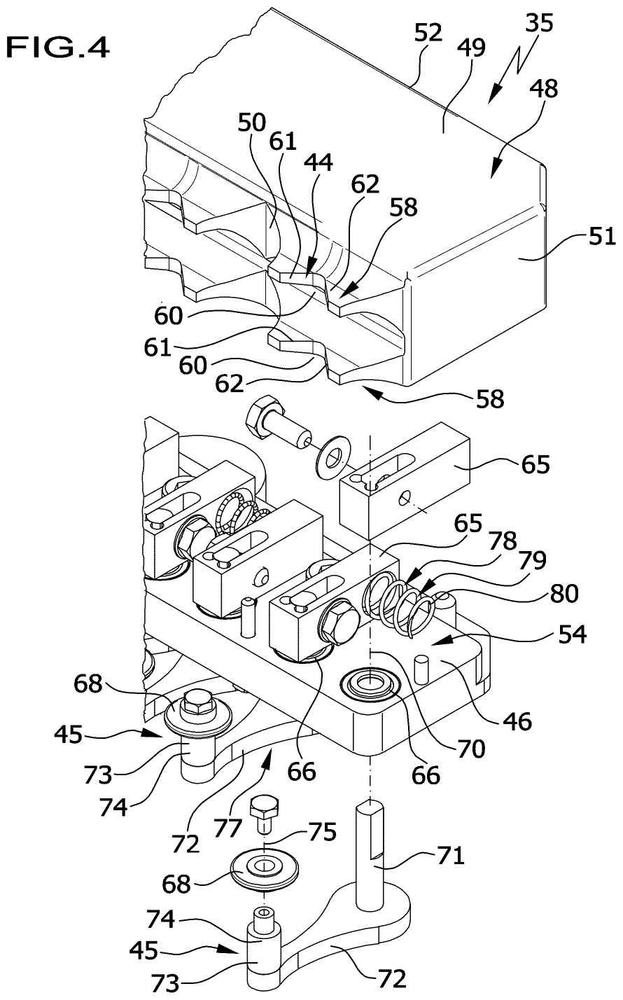

The holding device 35 comprises a main body 46. The main body 46 is substantially formed plate-shaped (FIG. 4). In the present example, the holding part 42 is fixed on the underside of the main body 46.

Position and orientation specifications, for example “on the side,” “on the underside” or the like, are, in the present case, based on an intended use of the holding device 35 and, in particular, on a direction of gravity 47. However, it is understood that the holding device 35 could also be used in a different orientation.

The holding device 45 comprises a cover element 48 covering the main body 46. The cover element 48 is configured to be hood-shaped with an upper wall 49, an end wall 50, side walls 51, and a rear wall 52. The walls 49, 50, 51 and 52 are free of openings.

The cover element 48 encases the main body 46 and together with it forms a housing 53 of the holding device 35. The main body 46 forms the bottom of the housing 53. The cover element 48 covers a receiving space 54 for components of the holding device 35.

A container receptacle 44 is arranged on the end wall 50. The container receptacle 44 defines a receptacle direction 56. In the present example, the containers 12 are aligned during the transfer to the holding device 35 so that a direction of extent 57 of the container 12 coincides with the receptacle direction 56 of the container receptacle 44 when the container 12 is held in the container receptacle 44.

The container receptacle 44 has at least one abutment element 58 for the container 12. In the present case, two abutment elements 58 are provided which are spaced apart from one another in the receptacle direction 56 (FIGS. 3 and 4). The abutment elements 58 are configured to be identical.

If the container 12 is positioned against the abutment elements 58, it assumes a defined target position on the holding device 35. This is advantageous for the transfer of containers 12 to the holding device 35 and vice versa to take over the containers 12. The defined position of the containers 12 ensures a high process reliability at the weighing station 30, the filling station 32 and the closing station 33, a high process reliability for weighing, filling and closing.

The container receptacle 44 comprises a recess 60 which is delimited by the abutment element 58. When viewed in the insertion direction 25, the recess 60 is concave. The recess 60 tapers in the insertion direction 25. In this way, the correct target position of the container 12 can preferably be ensured and said container can preferably be guided during insertion.

The abutment element 58 comprises two segments 61, 62 oriented relative to one another at an angle 63. The segments 61, 62 form legs of the angle, so to speak. In a plan view along the receptacle direction 56, the abutment element 58 is thereby configured to be substantially V-shaped (FIGS. 7 and 8). In the present example, the angle 63 is approximately 100° to 110°.

The target position of the container 12 can be more reliably ensured due to the two mutually spaced abutment elements 58. Any component tolerances can be compensated.

The abutment elements 58 are arranged on the end wall 50 and, in particular, formed integrally with the cover element 48. For example, the abutment elements 58 are molded onto the cover element 48.

The holding device 35 is in its entirety configured for pharmaceuticals in order to be used in highly sensitive and, in particular, toxic atmospheres. For this purpose, suitable stainless steel and suitable plastics material are used, for example. For example, the cover element 48 is made of a plastics material.

For holding the container 12 in the container receptacle 44, the holding device 35 comprises the already mentioned holding element 45. As already mentioned, two holding elements 45 are arranged on each container receptacle 44. In the present example, the holding elements 45 as well as the coupling elements 65 and the bearing elements 66 of the main body 46 coupled thereto are arranged and configured symmetrically with respect to a plane of symmetry 67. In the present example, the plane of symmetry 67 is described by the receptacle direction 56 and the insertion direction 25. In the present case, only a respective holding member 68 on each holding element 45 is excluded from the symmetry.

The bearing element 66 is accommodated in the main body 46. The bearing element 66 defines a pivot axis 70. The holding element 45 is pivotably mounted on the main body 46 via the bearing element 66 and is thereby pivotable relative to the main body 46 about the pivot axis 70.

In the present case, the pivot axis 70 is aligned parallel to the insertion direction 56. In relation to the transport direction 25, the pivot axis 70 is arranged behind the abutment elements 48.

The holding element 45 comprises a mounting portion 71 cooperating with the bearing element 66, a connecting portion 72 and a holding portion 73. The holding member 68 is arranged on the holding portion 73.

The mounting portion 71 passes through the bearing element 66 and engages in the receiving space 54 from below. The connecting portion 72 is in portions arranged below the main body 46 and protrudes from the main body 46.

The holding portion 73 is arranged on a free end of the connecting portion 72 facing away from the main body 46. The holding portion 73 has a holding projection 74. The holding member 68 is fixed to the holding projection 74.

In the present case, the mounting portion 71 and the holding projection 74 are aligned parallel to one another. The holding projection 74 projects upwards from the connecting portion 72 in the present example, just like the mounting portion 71.

In a plan view along the receptacle direction 56, the connecting portion 72 is configured to be substantially club-shaped. Starting from the main body 46, the connecting portion 72 tapers first in order to widen somewhat again at the free end.

During pivoting about the pivot axis 70, the connecting portion 72 is moved in a plane transverse and, in particular, perpendicular to the pivot axis 70.

In the present case, the holding member 68 is configured to be disc-shaped. In a plan view along the receptacle direction 56, the holding member 68 is circular. In the same plan view, the holding member 68 projects beyond the free end of the connecting portion 72.

The holding member 68 is dimensioned such that the container 12 contacts the holding member 68 during insertion into the container receptacle 44 as well as removal, and in the held state. However, in the format range covered by the holding device 35, the container 12 is free of contact with the connecting portion 72. For this purpose, for example, the club-shaped shape proves to be advantageous.

The holding member 68 is rotatable relative to the holding projection 74 and is, in particular, rotatably mounted thereon. The corresponding axis of rotation 75 is aligned parallel to the pivot axis 70 and parallel to the receptacle direction 56.

The holding member 68 is made of a preferably abrasion-resistant material and expediently is non-damaging to the material of the container 12. In particular, the container 12 remains undamaged when inserted into the container receptacle 44 and when removed from therefrom. For this purpose, the rotatable design of the holding member 68 is also advantageous, whereby friction with the lateral surface 17 is limited to the rolling friction.

As can be seen, in particular, from FIG. 3, the holding member 68 is arranged along the receptacle direction 56 between the abutment elements 58.

In the receptacle direction 56, the holding members 68 of the two holding elements 45 are arranged at different positions relative to the receptacle direction 56 and are positionable against the lateral surface 17 (FIG. 3). This can be implemented in a structurally simple manner, for example, in that the holding members 68 are mounted in mutually opposite orientations at the corresponding holding projection 74.

The coupling element 65 is arranged above the main body 46 in the receiving space 54. The coupling element 65 is preferably connected to the holding element 45. In particular, a positive-locking and/or force-locking connection is conceivable here. In the present case, a threaded element secures the connection. If the coupling element 65 is pivoted, the holding element 45 pivots and vice versa.

The holding element 45 and the coupling element 65 form a first lever arm or a second lever arm of a pivot body 77 pivotable about the pivot axis 70.

The holding device 35 comprises a biasing element 78 associated with a respective container receptacle 44. A common biasing element 78 is associated with the holding elements 45 on the container receptacle 44 (FIGS. 4 to 6).

In the present case, the biasing element 78 simultaneously acts as a return element 79 as explained below. In the present example, the biasing element 78 is configured as a spring 80. The spring 80 is, in particular, a compression spring.

The spring 80 engages in a respective recess 81 on the coupling element 65. The spring 80 can exert a force on the coupling element 65 in order to pivot it about the pivot axis 70. In this way, the spring 80 is indirectly operatively connected to the holding element 45, namely via the coupling element 65. Conversely, when the holding element 45 is pivoted via the coupling element 65, a force can be exerted on the spring 80 in order to compress it.

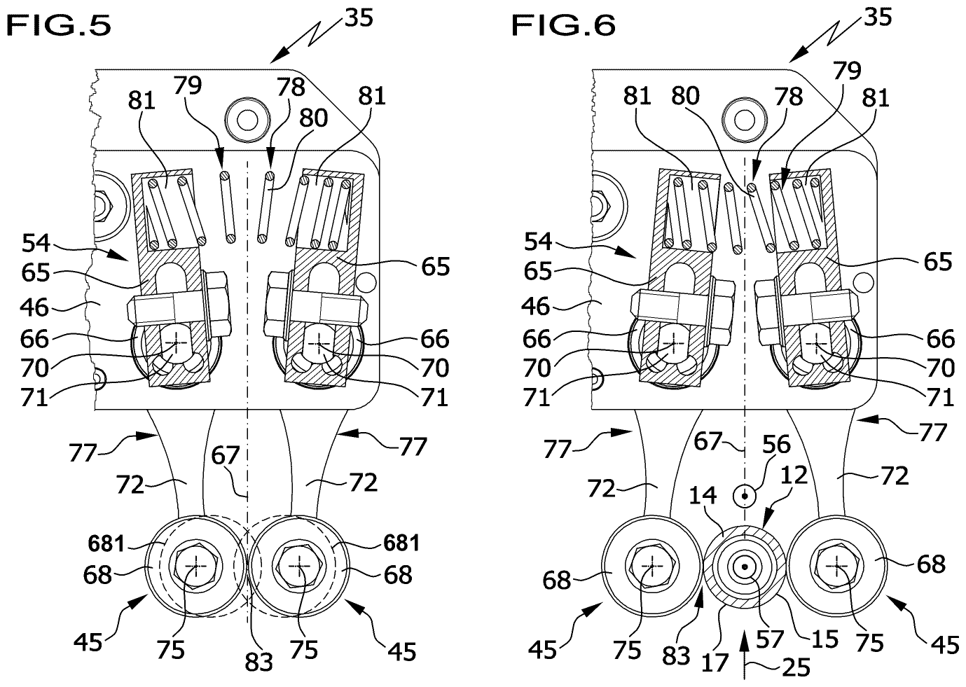

In the absence of a container 12 in the container receptacle 44, the holding elements 45 assume a base position relative to one another (FIG. 5). The spring 80 is dimensioned so that the holding elements 45 are approximated to one another. For example, the holding members 68 are positioned close to one another. For example, it may be provided that each holding member 68 is positioned against the respective other holding member 68 or against the holding projection 78 of the respective other holding element 45.

As a result of a height offset of the holding members 68, at least partially, in the receptacle direction 56 (FIG. 3), contours of the holding elements 45 can overlap in the base position, in deviation from the representation in accordance with FIG. 5, assuming a sufficiently strong spring 80. FIG. 5 shows, by way of example, the contours of the holding members 68 with reference signs 681 for this case.

In the base position of the holding elements 45, an expandable insertion opening 83, which is variable in size, of the container receptacle 44 is closed or narrowed.

For insertion into the container receptacle 44, the container 12 is moved in the insertion direction 25 with the transport device 21. In the present example, the insertion direction 25 is transverse and, in particular, perpendicular to the receptacle direction 56. In this way, a lifting movement of the container 12 during insertion into the container receptacle 44 can be avoided. In particular, the insertion direction 25 is arranged in a plane perpendicular to which the receptacle direction 56 is oriented.

Starting from the base position shown in FIG. 5, the holding elements 45 are transferrable into a release position against the return force of the spring, which acts as the return element 79 (FIGS. 6 and 7). When the container 12 contacts the holding members 68, the holding elements 45 are spread relative to one another. The insertion opening 83 is expanded until the holding elements 45 assume a release position. The spring 80 is compressed in the process.

During this process, both holding elements 45 are pivoted about the respective pivot axis 70, but in mutually opposite directions.

By coupling the coupling elements 65 to one another via the spring 80, it is possible to center the container 12. Any deviations result in a pivoting of both holding elements 45, so that the container 12 can be guided precisely into the container receptacle 45.

When the holding elements 45 assume the release position, the insertion opening 83 is expanded so far that the container 12 can be guided into the recess 60 to be positioned against the abutment elements 58 (FIGS. 6 and 7). Upon further movement of the container 12 with the transport device 21, the container 12 is positioned against the abutment elements 58 and assumes the correct target position.

Under the action of the biasing force of the spring 80 acting as biasing element 78, the holding elements 45 pivot from the release position into the holding position. In the holding position, the holding elements 45 engage behind the container 12. Via the holding members 68, the holding elements 45 act on the container 12, in particular, on the lateral surface 17 with a holding force. The holding force is directed toward the container receptacle 44. The container 12 is thereby held in a clamping manner in the container receptacle 44.

During the transfer into the holding position, the holding elements 45 pivot in opposite directions about the respective pivot axis 70 and thereby approach one another, while reducing the insertion opening 83. Due to the biasing force 78, the holding members 68 are already positioned against the lateral surface 17, while the pivoting from the release position into the holding position takes place. The rotation of the holding members 68 on the holding projections 74 prevents abrasion on the container 12 and on the holding members 68.

When the containers 12 are accommodated in the container receptacle 44, the gripping elements 23 can be moved relative to one another and the container 12 can be released (FIG. 8). The transport device 21 can then be retracted counter to the insertion direction 25 (arrow 85).

In order to remove the container 12, the procedure is reversed:

First, the transport device 21 is moved in the insertion direction 25 up to the containers 12 until the gripping elements 23, when they are brought close to one another, can grip the container 12. The transport device 21 is then retracted in the arrow direction 85.

Due to the contact with the container 12, the holding elements 45 pivot in mutually opposite directions about the respective pivot axis 70, whereby the holding elements 45 are pivoted from the holding position into the release position against the biasing force of the spring 80 and the insertion opening 83 is expanded.

Upon further retraction of the transport device 21 in the arrow direction 85, the container 12 passes out of the insertion opening 83. The holding elements 45 pivot in mutually opposite directions about the respective pivot axis 70 under the action of the return force of the spring 80.

Both when the containers 12 are inserted into the container receptacle 44 and when they are removed from the container receptacle 44, the holding elements 45 are first spread relative to one another and then moved together again. The spring 80 acts here once as a return element and once as a biasing element.

In a different embodiment of the present disclosure, it could be provided that the biasing element 78 is formed separately from the return element 79. For example, two springs 80 are used in this case.

Alternatively or additionally, for example, a magnetic coupling of the coupling elements 65 can take place.

Alternatively or additionally, it could be provided that the biasing element 78 and/or the return element 79 act/acts directly on the holding element 45.

It proves to be advantageous that the holding device 35 is free of a drive and that the holding elements 45 are transferrable from the base position into the release position and from the holding position into the release position by means of the containers.

The holding device 37 in accordance with FIGS. 9 and 10 will be discussed below. Like or functionally equivalent features and components are used with the same reference numerals. The advantages explained in connection with the holding device 35 can also be achieved with the holding device 37.

The holding device 37 is configured so that only one container 12 can be held thereon. Accordingly, it has only one container receptacle 44. However, in functional terms, relating to the holding elements 45 and their coupling via the coupling elements 65 and the spring 80, the design of the holding device 35 is identical. In this regard, reference can therefore be made in full to the above statements.

For the weighing process of the containers 12, separate holding devices 37 are used to decouple the individual weighing processes from one another and to increase the weighing accuracy.

The holding device 37 is connected to the weighing cell 31 via a support part 87.

In order to avoid any undesired excessive loading of the weighing cell 31 when the container 12 is inserted into the holding device 37 and during removal, a stop part 88 is provided.

The stop part 88 is jointly associated with the multiple holding devices 37. Pin-shaped stop elements 89 pass with play through corresponding openings 90 on the holding device 37. In this way, the amount of movement of the holding device 37 and thereby of the support part 87 is limited.

A different type of design of (a) stop element(s) may be provided. For example, a non-circular stop element is used, which is configured to be, for example, oval or elliptical and engages in a corresponding opening.

For the sake of clarity, only one holding device 37 is shown in FIGS. 9 and 10, just like only one container 12 and only one weighing cell 31.

It is understood that, in accordance with the number of transport means 21, just as many of these components may be provided on the weighing station 30, in the present case 12 pieces.

A single-place weighing station or a weighing station with two or more places, the number of which differs from the number of actuating devices 21, may be provided.

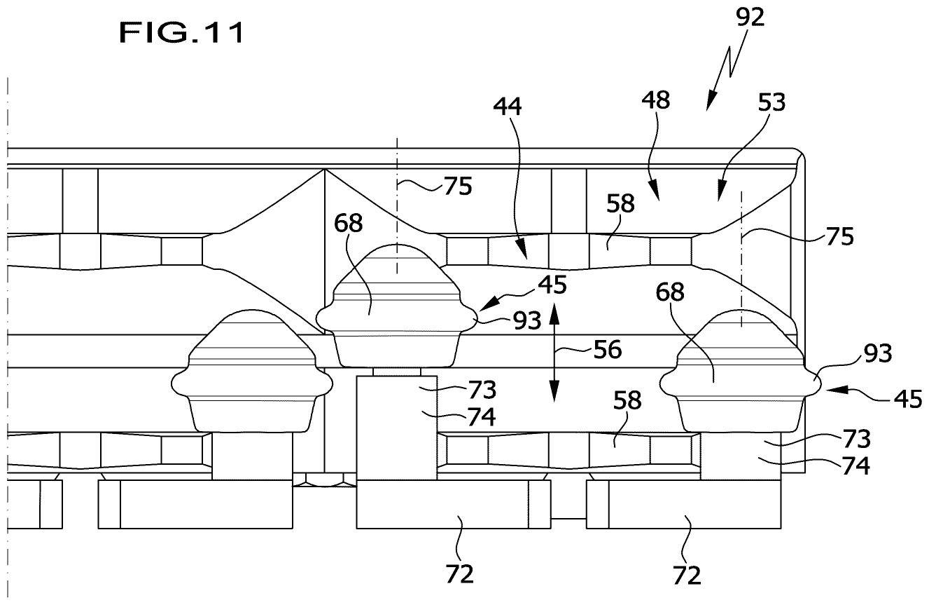

A preferred embodiment of the holding device in accordance with the present disclosure shown in part in FIG. 11 is denoted by the reference sign 92.

The holding device 92 differs from the holding device 35 in that the holding members 68 have a different shape. In the side view, the holding members 68 are of a shape that resembles a flattened onion shape on the upper side and has a bead-shaped projection 93 on the outer circumference.

In the holding device 92, the holding projections 74 have different lengths to ensure the distance between the holding members 68 in the receptacle direction 56.

In the holding device 92, the holding members 68 are preferably made of a soft material, for example from a soft rubber-like plastic. This makes it possible for the holding members 68 to roll gently on the containers 12. Damage to the containers, for example through scratches, can thereby be avoided.

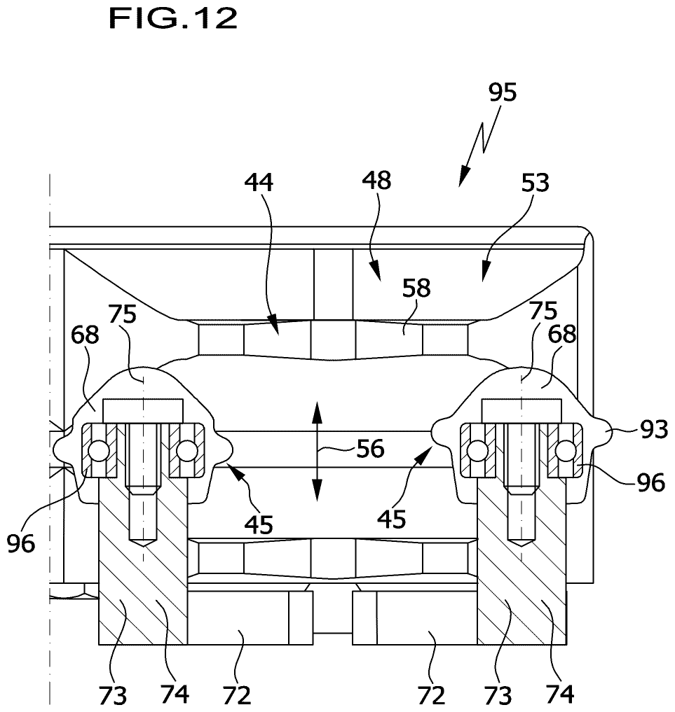

A preferred embodiment of the holding device in accordance with the present disclosure shown in part in FIG. 12 is denoted by the reference numeral 95. The holding device 95 is configured in relation to the holding members 68 similar to the holding device 92, wherein, in particular, holding members 68 made of soft rubber-like plastic can also be used with the same advantage as mentioned above.

The holding members 68 are mounted on the respective holding portion 73 so as to be rotatable about the axis of rotation 75 via a bearing element 96 configured as a ball bearing. By using the ball bearing, the holding device 95 is particularly durable.

The holding members 68 overlap the respective bearing element 68 and seal it off. A penetration of dirt and/or a product to be filled can thereby be avoided.

In the holding device 95, the holding portions 73 are of equal length along the receptacle direction 56. The projections 93 on the holding members 68 are positioned differently along the receptacle direction 56 so that the holding members 68 are positionable against the container 12 at different positions in relation to the receptacle direction 56.

### LIST OF REFERENCE NUMERALS

10 Apparatus
12 Container
14 Syringe
15 Syringe body
16 Needle guard
17 Lateral surface
18 Finger flange
20 Transport system
21 Transport device
22 Holding part
23 Gripping element
24 Transport direction
25 Insertion direction
26 Drive device
28 Coupling element
29 Decoupling element
30 Weighing station
31 Weighing cell
32 Filling station
33 Closing station
35 Holding device
37 Holding device
39 Control device
40 Frame
42 Holding part
44 Container receptacle
45 Holding element
46 Main body
47 Direction of gravity
48 Cover element
49 Upper wall
50 Front wall
51 Side wall
52 Rear wall
53 Housing
54 Receiving space
56 Receptacle direction
57 Direction of extent
58 Abutment element
60 Recess
61 Segment
62 Segment
63 Angle
65 Coupling element
66 Bearing element
67 Plane of symmetry
68 Holding member
681 Contour of holding member
70 Pivot axis
71 Mounting portion
72 Connecting portion
73 Holding portion
74 Holding projection
75 Axis of rotation
77 Swivel body
78 Biasing clement
79 Return clement
80 Spring
81 Recess
83 Insertion opening
85 Arrow
87 Support part
88 Stop part
89 Stop element
90 Opening
92 Holding device
93 Projection
95 Holding device
96 Bearing element

1. A holding device for holding a container, the container being a longitudinally extending pharmaceutical container having a direction of extent in an apparatus for processing of containers, the holding device comprising a main body, a container receptacle having at least one abutment element for the container, against which at least one abutment element the container is positionable in order to assume a defined position on the holding device, wherein the direction of extent extends in a receptacle direction of the container receptacle, and at least one holding element for holding the container in the container receptacle, wherein the at least one holding element is movably mounted on the main body and is transferrable from a release position, in which the container is insertable into the container receptacle in an insertion direction, which is oriented transversely or perpendicularly, in relation to the receptacle direction, into a holding position in which the at least one holding element engages behind the container at least in portions and, in order to hold it with clamping action, acts upon said container with a holding force in the direction of the container receptacle.

2. The holding device according to claim 1, wherein the holding device comprises at least one biasing element for acting upon the at least one holding element with a biasing force acting in the direction of the holding position.

3. The holding device according to claim 2, wherein the at least one biasing element is configured as a mechanical spring which is operatively connected to the at least one holding element, or that the at least one biasing element is or forms a magnetic element.

4. The holding device according to claim 3, wherein, starting from a base position which the at least one holding element assumes when no container is present in the container receptacle, the at least one holding element is transferrable against an action of at least one return element into the release position and under the action of the at least one return element from the release position into the base position.

5. The holding device according to claim 4, wherein the at least one biasing element comprises or forms the at least one return element.

6. The holding device according to claim 4, wherein by widening an insertion opening of the container receptacle the at least one holding element is transferrable from the base position into the release position and by reducing the insertion opening from the release position into the holding position, and wherein by widening the insertion opening the at least one holding element is transferrable from the holding position into the release position and by reducing the insertion opening from the release position into the base position.

7. The holding device according to claim 4, wherein the at least one holding element is transferrable from the holding position into the release position and/or from the base position into the release position by means of the container.

8. The holding device according to claim 4, wherein the at least one holding element comprises or forms two holding elements movably mounted on the main body which receive the container between them at least in the holding position.

9. The holding device according to claim 8, wherein the two holding elements, starting from a respective release position, approach one another during transfer into a corresponding holding position and are conversely moved away from one another, and/or in that the two holding elements are moved away from one another starting from a corresponding base position during transfer into a corresponding release position, and vice versa.

10. The holding device according to claim 8, wherein the two holding elements are arranged and/or configured symmetrically or substantially symmetrically relative to one another in relation to a plane of symmetry through the container receptacle.

11. The holding device according to claim 8, wherein the two holding elements are directly or indirectly coupled to one another, wherein a biasing element and/or a return element of the holding device engages directly or indirectly on the two holding elements and pretensions these relative to one another with respect to the holding position and/or the base position.

12. The holding device according to claim 11, wherein coupling of the two holding elements ensures self-centering of the two holding elements when the container is inserted into or removed out of the container receptacle.

13. The holding device according to claim 1, wherein the holding device is free of a drive for the at least one holding element.

14. The holding device according to claim 1, wherein the at least one holding element is pivotable on the main body about a pivot axis.

15. The holding device according to claim 14, wherein:
the pivot axis extends parallel to the receptacle direction; and/or
the pivot axis is arranged behind the at least one abutment element relative to the insertion direction; and/or
the pivot axis extends transversely and/or perpendicularly to a plane of the main body.

16. The holding device according to claim 14, wherein the holding device comprises at least one coupling element which is connected to the at least one holding element so as to be pivotally fixed therewith and is arranged at least in portions on a side of the pivot axis opposite to the at least one holding element.

17. The holding device according to claim 16, wherein:
at least one biasing element and/or at least one return element of the holding device engages on the at least one coupling element; and/or
the at least one holding element comprises two holding elements, the at least one coupling element comprises two coupling elements, and the at least one biasing element and/or the at least one return element acts between the two coupling elements.

18. The holding device according to claim 1, wherein the at least one holding element comprises a mounting portion for movable mounting on the main body, a holding portion for positioning against the container when the at least one holding element is in the holding position, and a connecting portion connecting the mounting portion to the holding portion.

19. The holding device according to claim 18, wherein:
the connecting portion extends, starting from the main body, counter to the insertion direction and/or is arranged laterally next to the container when the container is received in the container receptacle; and/or
the mounting portion engages in relation to a direction of gravity from below into the main body and/or a housing of the holding device, wherein the connecting portion is arranged in portions below the main body.

20. The holding device according to claim 18, wherein a holding member for positioning against the container is arranged or formed on the holding portion, which holding member relative to a plan view along the receptacle direction, projects beyond a free end of the connecting portion which faces away from the main body.

21. The holding device according to claim 20, wherein the holding member is rotatable relative to a holding projection of the holding portion protruding from the connecting portion.

22. The holding device according to claim 21, wherein:
an axis of rotation of the holding member is oriented parallel to a container direction; and/or
a bearing element is provided on the holding projection, via which the holding member is rotatably mounted on the holding projection.

23. The holding device according to claim 20, wherein the holding member is manufactured from abrasion-resistant material and/or from a material that is non-damaging to the container.

24. The holding device according to claim 20, wherein the at least one holding element comprises two holding elements with a respective holding member which are positionable against the container at different positions in relation to the receptacle direction.

25. The holding device according to claim 1, wherein the holding device comprises or forms a cover element which covers the main body at least in portions or is free of openings on an upper side.

26. The holding device according to claim 25, wherein the at least one abutment element is arranged on an end face of the cover element with respect to the insertion direction.

27. The holding device according to claim 25, wherein the main body together with the cover element forms a housing of the holding device in which at least one biasing element and/or return element acting directly or indirectly on the at least one holding element is arranged.

28. The holding device according to claim 1, wherein the container receptacle comprises a recess partially delimited by the at least one abutment element, into which recess the container is at least partially insertable and which tapers in the insertion direction.

29. The holding device according to claim 1, wherein the at least one abutment element comprises two segments which are aligned relative to one another at an angle for respective positioning against the container and/or the at least one abutment element is configured V-shaped or C-shaped in a plan view along the receptacle direction.

30. The holding device according to claim 1, wherein the container receptacle comprises two abutment elements spaced apart along the receptacle direction.

31. The holding device according to claim 1, wherein the container is arranged in a freely suspended manner in the container receptacle, wherein the holding device is free of a set-down element for the container.

32. The holding device according to claim 1, wherein the holding device is configured for holding a plurality of containers and comprises a plurality of container receptacles arranged laterally next to one another, wherein at least one holding element mounted movably on a main body is arranged in each case on each container receptacle for holding a corresponding container in a holding position.

33. The holding device according to claim 32, wherein a common main body is provided on which the at least one holding element is movably mounted and/or in that the holding device comprises or forms a common cover element for the main body.

34. An apparatus for processing pharmaceutical containers, the apparatus comprising:
at least one holding device according to claim 1; and
at least one transport device for transferring the containers to the at least one holding device and to take over the containers from the at least one holding device.
